(19) United States
(12) Patent Application Publication
(10) Pub. No.: US 2016/0224990 A1
(43) Pub. Date: Aug. 4, 2016

(54) CUSTOMER HEALTH TRACKING SYSTEM BASED ON MACHINE DATA AND HUMAN DATA

(71) Applicant: AppDynamics Inc., San Francisco, CA (US)

(72) Inventors: Hatim Shafique, Redwood City, CA (US); Arpit Patel, Fremont, CA (US); Vikash Kumar, Fremont, CA (US)

(21) Appl. No.: 14/609,308

(22) Filed: Jan. 29, 2015

(51) Int. Cl. G06Q 30/02; H04L 29/08

(52) U.S. Cl. CPC G06Q 30/0201; H04L 67/22

(57) ABSTRACT

A system allows a provider to better monitor the health of customer accounts. The present system monitors customer utilization and adoption of their product using machine data along with human evaluation data. The customer may be monitored in several areas of usage with a product. The monitoring results include machine data (usage data) which is combined with human input to generate a health score for a customer. Once the health score is determined, action items may be assigned, a renewal possibility may be considered for future business, and expansion possibilities may be determined.

### BACKGROUND OF THE INVENTION

The World Wide Web has expanded to provide web services faster to consumers. For companies that rely on web services to implement their business, it is very important to provide a reliable web services. Many companies that provide web services utilize application performance management products to keep their web services running well. The companies that provide application performance management must ensure that their customers web services are healthy in order to maintain companies as customers.

Customer health systems typically involve monitoring the number of logins performed by the customer. This single metric does measure an activity of the customer with a product, but does not provide a valuable indicator for how well a customer is engaged with the product. The single login metric also provides no context for how the customer experience is proceeding.

What is needed is an improved system for determining customer utilization of a product to better determine the health of a customer account.

### SUMMARY OF THE CLAIMED INVENTION

The present technology, roughly described, provides a system that allows a provider to better monitor the health of customer accounts. The present system monitors customer utilization and adoption of their product using machine data along with human evaluation data. The customer may be monitored in several areas of usage with a product. The monitoring results include machine data (usage data) which is combined with human input to generate a health score for a customer. Once the health score is determined, action items may be assigned, a renewal possibility may be considered for future business, and expansion possibilities may be determined.

An embodiment may include a method for determining the health of a network application customer. One or more agents may monitor usage of an application management system. The one or more agents executing on one or more servers that implement the application management system. Usage data may be automatically collected by a controller for the application management system from the one or more agents. The controller may receive a human generated score associated with the entity using the application management system. The controller may generate a health score for the entity based on the automatically collected data and the human generated score. The health score may be reported to the entity.

An embodiment may include a system for monitoring a business transaction. The system may include a processor, a memory and one or more modules stored in memory and executable by the processor. When executed, the one or more modules may monitor by one or more agents a usage of an application management system, the one or more agents executing on one or more servers that implement the application management system, automatically collect usage data for the application management system from the one or more agents, receive a human generated score associated with the entity using the application management system, generate a health score for the entity based on the automatically collected data and the human generated score, and report the health score to the entity.

### BRIEF DESCRIPTION OF THE DRAWINGS

FIG. 1 is a system for monitoring product adoption.

FIG. 2 is a block diagram of a controller.

FIG. 3 is a method for monitoring product adoption.

FIG. 4 is a method for determining adoption level.

FIG. 5 is a method for calculating usage points

FIG. 6 is an exemplary interface providing a dashboard.

FIG. 7 is an exemplary interface providing a custom health report.

FIG. 8 an exemplary interface providing a renewal possibility report.

FIG. 9 is an exemplary interface providing a usage report.

FIG. 10 is an exemplary interface providing an expansion possibility report.

FIG. 11 is an exemplary interface providing customer usage trends.

FIG. 12 is a block diagram of a system for implementing the present technology.

### DETAILED DESCRIPTION

The present technology provides a system that allows a provider to better monitor the health of customer accounts. The present system monitors customer utilization and adoption of their product using machine data along with human evaluation data. The customer may be monitored in several areas of usage with a product. The monitoring results include machine data (usage data) which is combined with human input to generate a health score for a customer. Once the health score is determined, action items may be assigned, a renewal possibility may be considered for future business, and expansion possibilities may be determined.

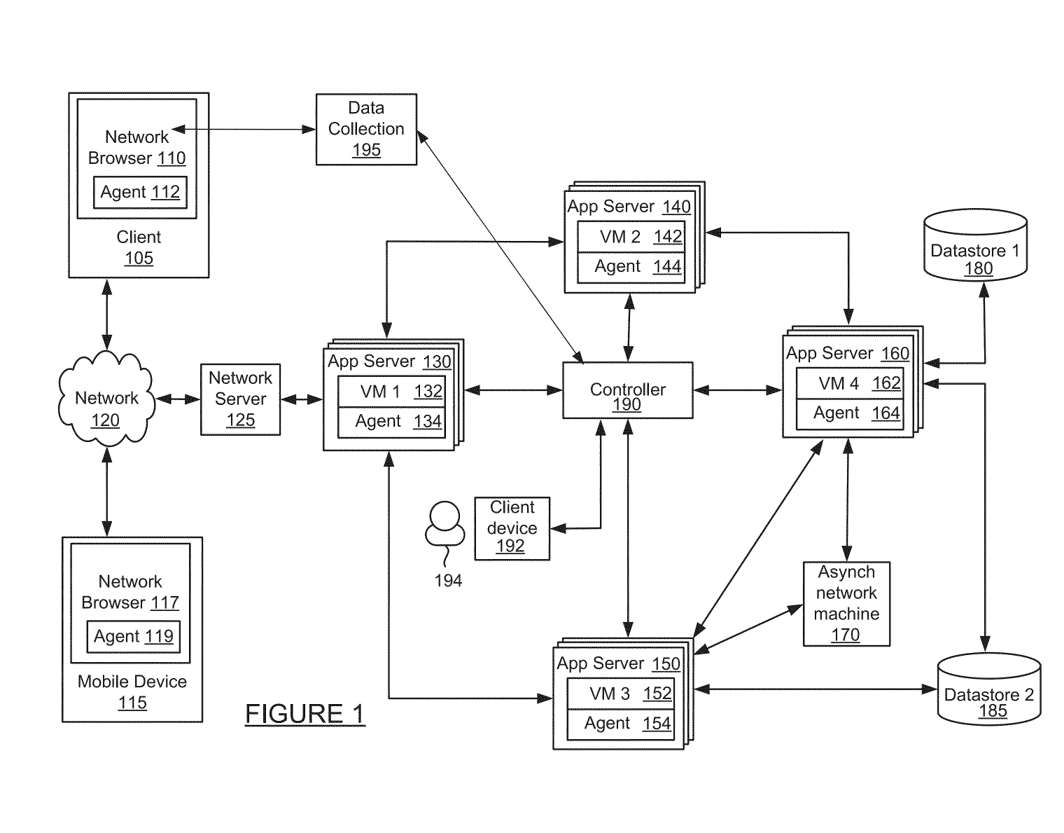

FIG. 1 is a block diagram of a system for monitoring product adoption. System 100 of FIG. 1 includes client device 105 and 192, mobile device 115, network 120, network server 125, application servers 130, 140, 150 and 160, asynchronous network machine 170, data stores 180 and 185, and controller 190.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120. Mobile device 115 is connected to network 120 and may be implemented as a portable device suitable for receiving content over a network, such as for example a mobile phone, smart phone, tablet computer or other portable device. Both client device 105 and mobile device 115 may include hardware and/or software configured to access a web service provided by network server 125.

Network 120 may facilitate communication of data between different servers, devices and machines. The network may be implemented as a private network, public network, intranet, the Internet, a Wi-Fi network, cellular network, or a combination of these networks.

Network server 125 is connected to network 120 and may receive and process requests received over network 120. Network server 125 may be implemented as one or more servers implementing a network service. When network 120 is the Internet, network server 125 may be implemented as a web server. Network server 125 and application server 130 may be implemented on separate or the same server or machine.

Application server 130 communicates with network server 125, application servers 140 and 150, controller 190. Application server 130 may also communicate with other machines and devices (not illustrated in FIG. 1). Application server 130 may host an application or portions of a distributed application and include a virtual machine 132, agent 134, and other software modules. Application server 130 may be implemented as one server or multiple servers as illustrated in FIG. 1, and may implement both an application server and network server on a single machine.

Application server 130 may include applications in one or more of several platforms. For example, application server 130 may include a Java application, .NET application, PHP application, C++ application, or other application. Different platforms are discussed below for purposes of example only.

Virtual machine 132 may be implemented by code running on one or more application servers. The code may implement computer programs, modules and data structures to implement, for example, a virtual machine mode for executing programs and applications. In some embodiments, more than one virtual machine 132 may execute on an application server 130. A virtual machine may be implemented as a Java Virtual Machine (JVM). Virtual machine 132 may perform all or a portion of a business transaction performed by application servers comprising system 100. A virtual machine may be considered one of several services that implement a web service.

Virtual machine 132 may be instrumented using byte code insertion, or byte code instrumentation, to modify the object code of the virtual machine. The instrumented object code may include code used to detect calls received by virtual machine 132, calls sent by virtual machine 132, and communicate with agent 134 during execution of an application on virtual machine 132. Alternatively, other code may be byte code instrumented, such as code comprising an application which executes within virtual machine 132 or an application which may be executed on application server 130 and outside virtual machine 132.

In embodiments, application server 130 may include software other than virtual machines, such as for example one or more programs and/or modules that processes AJAX requests.

Agent 134 on application server 130 may be installed on application server 130 by instrumentation of object code, downloading the application to the server, or in some other manner. Agent 134 may be executed to monitor application server 130, monitor virtual machine 132, and communicate with byte instrumented code on application server 130, virtual machine 132 or another application or program on application server 130. Agent 134 may detect operations such as receiving calls and sending requests by application server 130 and virtual machine 132. Agent 134 may receive data from instrumented code of the virtual machine 132, process the data and transmit the data to controller 190. Agent 134 may perform other operations related to monitoring virtual machine 132 and application server 130 as discussed herein. For example, agent 134 may identify other applications, share business transaction data, aggregate detected runtime data, and other operations.

Agent 134 may be a Java agent, .NET agent, PHP agent, or some other type of agent, for example based on the platform which the agent is installed on.

Each of application servers 140, 150 and 160 may include an application and an agent. Each application may run on the corresponding application server or a virtual machine. Each of virtual machines 142, 152 and 162 on application servers 140-160 may operate similarly to virtual machine 132 and host one or more applications which perform at least a portion of a distributed business transaction. Agents 144, 154 and 164 may monitor the virtual machines 142-162 or other software processing requests, collect and process data at runtime of the virtual machines, and communicate with controller 190. The virtual machines 132, 142, 152 and 162 may communicate with each other as part of performing a distributed transaction. In particular each virtual machine may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. Controller 190 may receive runtime data from each of agents 134-164, associate portions of business transaction data, communicate with agents to configure collection of runtime data, and provide performance data and reporting through an interface. The interface may be viewed as a web-based interface viewable by mobile device 115, client device 105, or some other device. In some embodiments, a client device 192 may directly communicate with controller 190 to view an interface for monitoring data.

Controller 190 may install an agent into one or more virtual machines and/or application servers 130. Controller 190 may receive correlation configuration data, such as an object, a method, or class identifier, from a user through client device 192.

Controller 190 may collect and monitor customer usage data collected by agents on customer application servers and analyze the data. The controller may report the analyzed data via one or more interfaces, including but not limited to a dashboard interface and one or more reports.

Data collection server 195 may communicate with client 105, 115 (not shown in FIG. 1), and controller 190, as well as other machines in the system of FIG. 1. Data collection server 195 may receive data associated with monitoring a client request at client 105 (or mobile device 115) and may store and aggregate the data. The stored and/or aggregated data may be provided to controller 190 for reporting to a user.

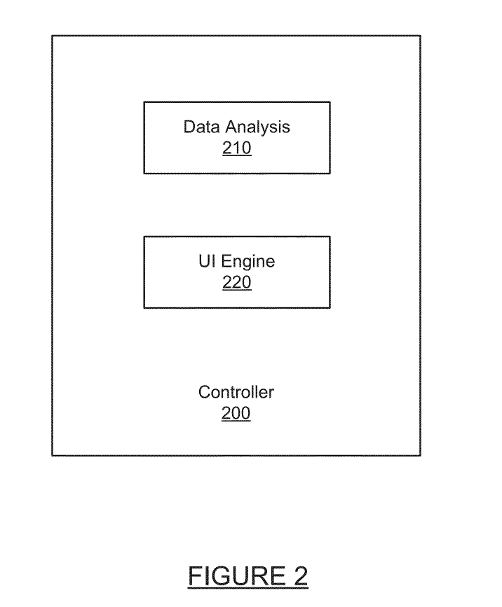

FIG. 2 is a block diagram of a controller. The controller 200 of FIG. 2 may provide more detail for controller 190 of the system of FIG. 1. Controller 200 includes data analysis module 210 and user interface engine 220. Data analysis module 210 may receive data from multiple sources. The sources may include one or more agents in the system of FIG. 1. In particular, customer usage data may be received from agents executing on different application servers. Usage data may also be received from customer requests made to the controller, such as for example a login request. In addition to usage data, data analysis module 210 may receive information from websites such as LinkedIn that may include data on customer employees.

Data analysis module 210 may also access data provided by an administrator, such as a CRM rating and a technology rating. Data analysis to 10 may, upon receiving the data, generate data to be provided through a dashboard or report for use of an administrator.

UI engine 220 may provide one or more interfaces to a user. The interfaces may be provided to an administrator through a network-based content page, such as a webpage, through a desktop application, a mobile application, or through some other program interface. The user interface may provide the data and formatting for reviewing reports, providing a dashboard, and other interface viewing and activity.

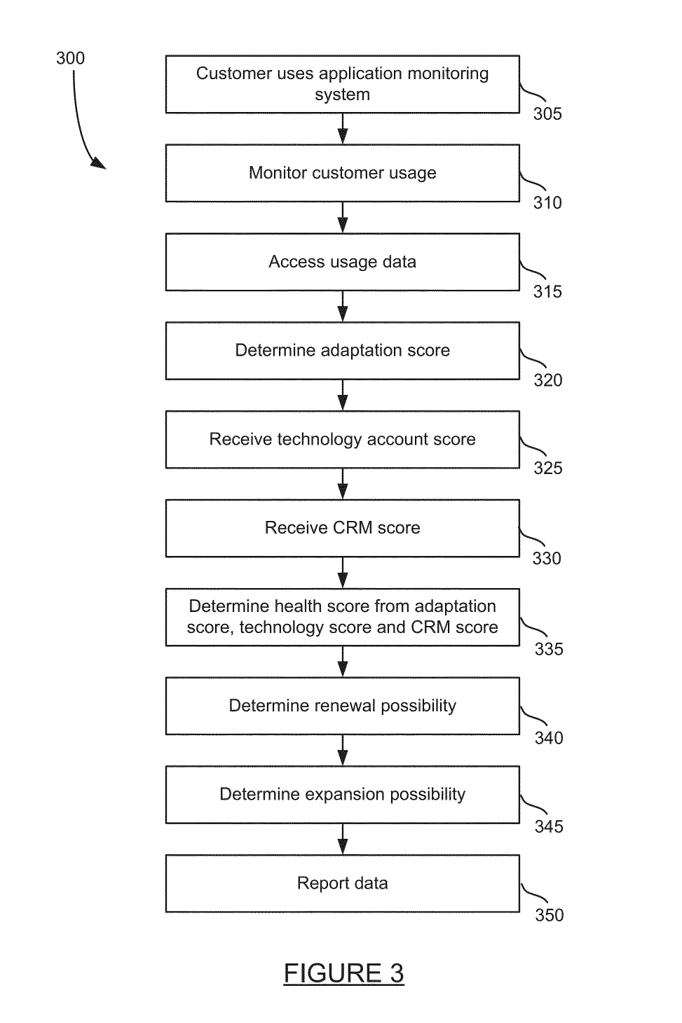

FIG. 3 is a method for monitoring product adoption. First, a customer may use an application monitoring system at step 305. Use of the system may include installing the system, configuring the system, and using the system to monitor web applications that implement, support or are otherwise associated with their business.

Customer usage may then be monitored at step 310. The usage may be monitored through agents installed on application servers. For example, usage monitoring may include whether the customer has downloaded the application, installed and configured the application, whether the customer is using features such as alerts and a dashboard, and activities. Customer usage monitoring may also include keeping track of customer service issues, such as tickets for technical assistance, which are requested and handled by the product provider.

The usage data may be accessed at step 315. Accessing the data may include gathering the data, aggregating portions of the data, storing the data and accessing the data by a controller.

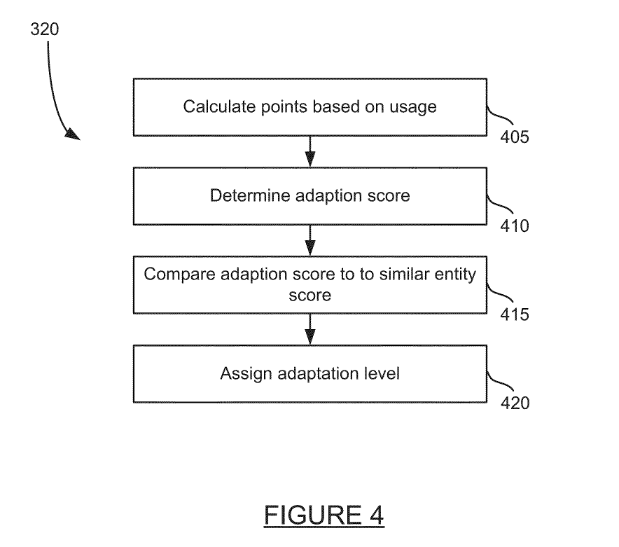

An adoption level for a particular customer may be determined at step 320. The adoption level may be determined based on data collected and/or generated (machine data) and administrator or user generated data. Determining an adoption level is discussed in more detail below with respect to the method of FIG. 4.

A technology score may be received at step 325. The technology score be determined by a human and may represent the extent to which the technology has worked for the customer. For example, the technology score may be provided by a technical account manager for the particular customer account.

A CRM score may be received at step 330. The CRM score may be provided by a human and may represent the relationship with the customer.

A health score is determined from an adoption score, technology score and CRM score at step 335. In some instances, the health score may be determined by averaging scores, applying a weighted value to the scores, or in some other manner.

In some instances, the health score may generated as a risk score. For example, a health score may be determined in part from an externally generated adoption score, an internally generated adoption score, usage activity, and customer support. For example, an adoption score from an external customer relationship management company may be in the range of 0 to 3, and 25 points may be provided per level within that range. The internally generated adoption score may have a range of 1 to 10, and may be used to generate points towards a risk value. The download activity may be scored as five points for down per download with a maximum of 20 points. The cases for customer support may be scored as a negative number of points per support case. Different levels of support cases may be scored differently, with more important or major support cases scored higher than less serious cases. The total points are then compared to ranges, and a corresponding risk label is assigned to the customer based on the range that includes the points total for the customer.

A renewal possibility may be determined at step 340. The renewal possibility may be determined in part from the usage data as well as by other data, including a technical score and other user input. The renewal possibility may be provided in terms of a percentage, a classification, or some other score.

An expansion possibility may be determined at step 345. The expansion possibility may indicate the possibility of whether the customer will expand their use of the product. The expansion possibility may be determined for companies with an IT budget and without an IT budget. For companies with an IT budget, the percentage of an application program management budget may be determined per industry as the average of the deal size divided by the IT budget, with that amount multiplied by 100 times the percent APM budget by industry. The estimated APM spending may then be determined by the percentage APM budget divided by hundred times the IT budget. The expansion possibility may then be determined by comparing the estimated APM spending to the deal size. If a deal size is greater than an estimated APM spending, there is no possibility of expansion. Otherwise, there may be a possibility of expansion. The expansion amount may be determined by subtracting the deal size from the estimated APM spending.

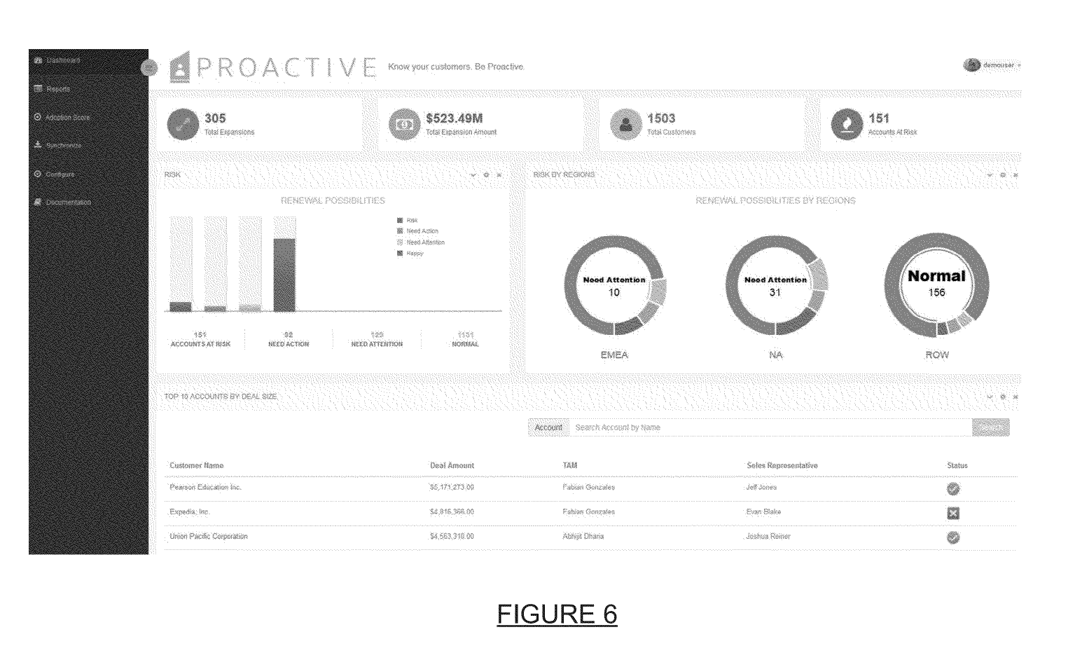

Data may be reported at step 350. Data reporting may be done through any of a number of interfaces including a dashboard interface as well as one or more reports. Data may be reported in real time, based on agent reporting to a controller which provides the reported data. Reporting through a dashboard, health report, usage report, and other interfaces is illustrated in FIGS. 6 through 11.

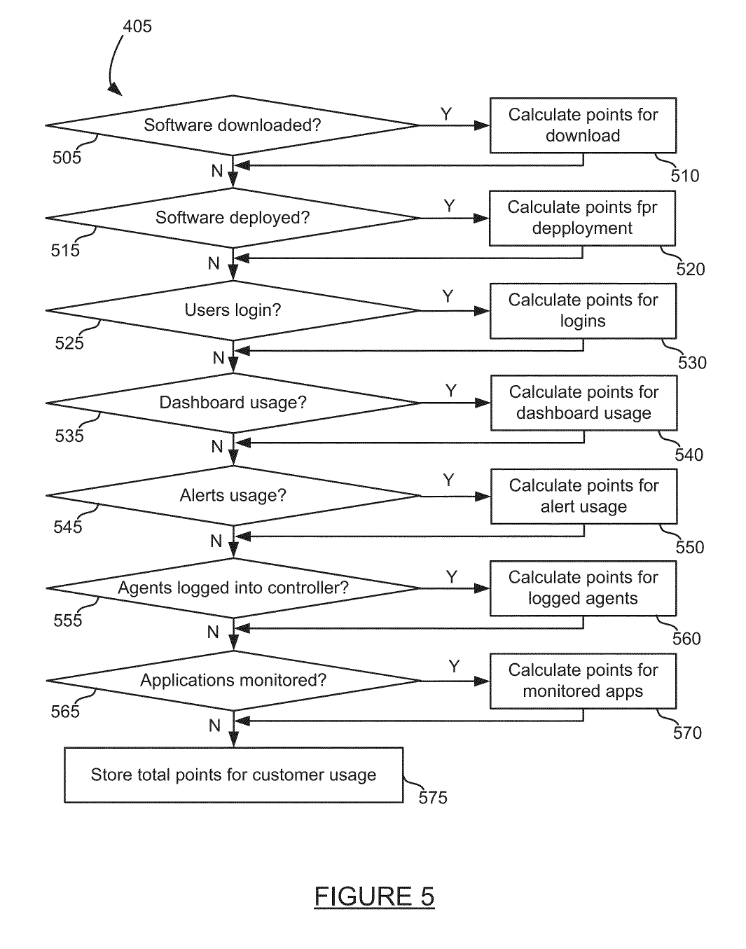

FIG. 4 is a method for determining an adoption level. The method of FIG. 4 provides more detail for step 320 of the method of FIG. 3. First, points are calculated based on usage at step 305. Points may be calculated based on a wide variety of usage types, including system configuration, user activity, and other events that can be monitored. More detail for calculating points based on usage is discussed below with respect to the method of FIG. 5.

An adoption score is determined at step 310. The adoption score is determined as the total of the points calculated at step 305. The adoption score is then compared to adoption scores of similar entities at step 315. Entities may be similar if they are in the same industry, have a similar company size, have similar revenues, and other factors. An adoption level is then assigned at step 320. The adoption level may be assigned based on the adoption score determined at step 310 and a range of adoption scores for similar entities. The adoption level, for example, may have one of three levels consisting of “at risk,” “needs attention,” and “good.”

FIG. 5 is a method for calculating points based on usage. The method of FIG. 5 provides more detail for step 405 of the method of FIG. 4. First, a determination is made as to whether software has been downloaded by the customer at step 505. If software has not been downloaded, the method of FIG. 5 continues to step 515. If the software has been downloaded, points are calculated for the download at step 510 and the method continues to step 515.

A determination as to whether software has been deployed is made at step 515. If software has not been deployed, the method continues to step 525. If software has been deployed, points are calculated for the deployment and the method continues to step 525.

A determination is made as a whether users have logged in at step 525. If users have not logged into the administrative interface or other portion of the product provided to the customer, the method continues to step 535. If users have logged in, points for logins are calculated at step 530. In some instances, a certain number of points are allotted for each login user, as well as each login within the last thirty days for a particular user.

A determination is made as to whether any dashboard usage has occurred at step 535. If the dashboard has not been used by the customer, the method of FIG. 5 continues to step 545. If the dashboard has been used, points are calculated for the dashboard usage at step 540. Points may be accumulated for each use or access of the dashboard as well as accessing different portions of the dashboard.

Next, a determination is made as to whether there is usage of alerts at step 545. If alerts are not used, the method of FIG. 5 continues to step 555. If alert usage is detected, points are calculated for the alert usage at step 550 and the method continues to step 555.

A determination is made as to whether any agents are logged into a controller for the customer at step 555. If no agents are logged into a controller, the method of FIG. 5 continues to step 565. If agents are logged into a controller, points for the logged-in agents are calculated at step 560 and the method continues to step 565. A determination is made as to whether any applications are being monitored at step 565. If no applications are monitored for the customer, the method continues to step 575. If applications are being monitored, points are calculated for the monitored applications at step 570 and the method continues to step 575.

Total points for customer usage is determined at step 575. The total points may be the summary of the points calculated at steps 510, 20, 530, 540, 550, 560, and 570. The total usage points may be stored for later use by the controller.

FIG. 6 is an exemplary interface providing a dashboard. The dashboard of FIG. 6 provides a variety of information, the display and selection of which is configurable. In the dashboard of FIG. 6, the provided information includes the total number of customers with possible expansions, the total expansion amount, the total customers, and the number of accounts at risk. Another window in the dashboard displays risk in the form of bar graphs showing renewal possibilities. The risk window indicates the number of accounts at risk, the number of accounts that need action, the number of accounts that need attention, and the number of accounts that are happy and have a normal status. The risk is also shown by regions, with each region shown with the renewal possibility within that region. The dashboard also provides the top ten accounts by deal size as well as their health status. Within the dashboard, an administrator may access reports, adoption scores, configure the dashboard and report settings, and may synchronize data.

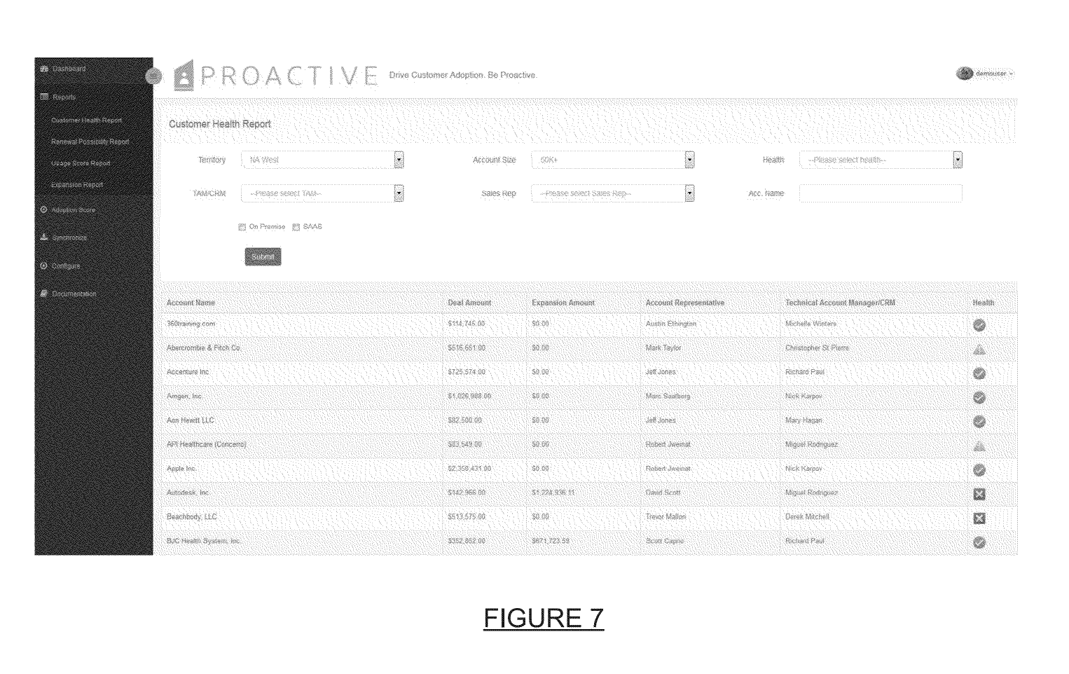

FIG. 7 is an exemplary interface providing a customer help report. The customer help report of FIG. 7 may be accessed through a report tab of the dashboard shown in FIG. 6. The customer help report interface allows administrator to select filters such as territory, account size, health, technology account manager (TAM) score and CRM, sales representative, and account name. With any filters selected, or with no filters, accounts for the particular company as well as their health is shown in the health report. Details shown in the health report of FIG. 7 include the account name, deal amount, expansion amount, account representative, technical account manager, and an indication of the health. In the interface of FIG. 7, indication of help is provided as an icon representing one of multiple levels of health. In FIG. 7, a green checkmark indicates that they health is good, an exclamation mark within a triangle Indicates that the health needs attention, and an “X” within a box indicates that the account is at risk.

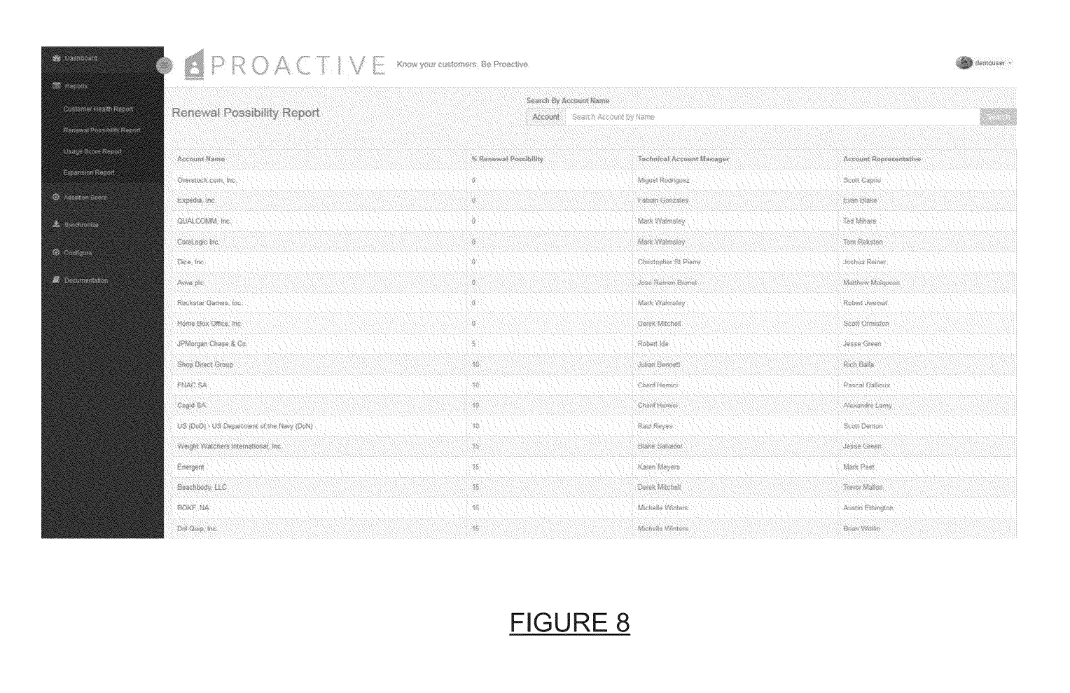

FIG. 8 is an exemplary interface providing the renewal possibility report. The renewal possibility report may be accessed from the reports tab of the dashboard of FIG. 6. The renewal possibility report includes a percentage of likelihood that accounts will be renewed by a particular client. The report provides columns of data such as account name, percent renewal possibility, technical account manager, and account representative.

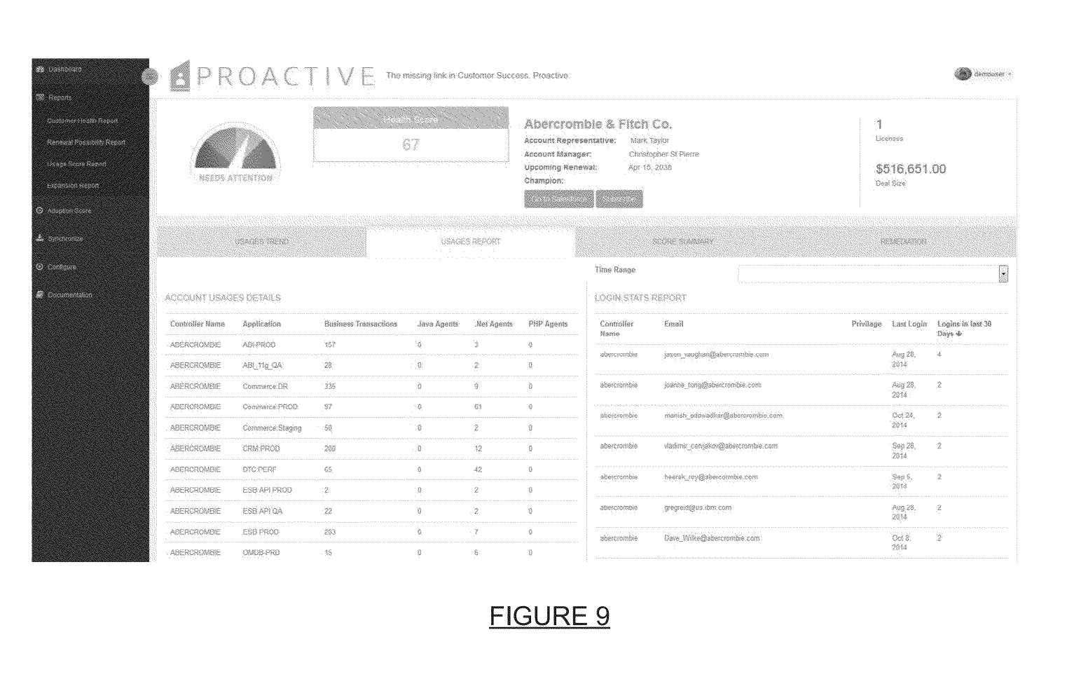

FIG. 9 is an exemplary interface providing a usage report. The usage report may include account usage data such as a controller, application, business transactions, Java agents, .Net agents, and PHP agents. The usage information indicates how often the particular agents and business transactions are accessed by the particular controller. The usage report also includes login stats statistics. The login statistics indicate a controller name, email, the last login. and the number of logins in the last 30 days by the particular email.

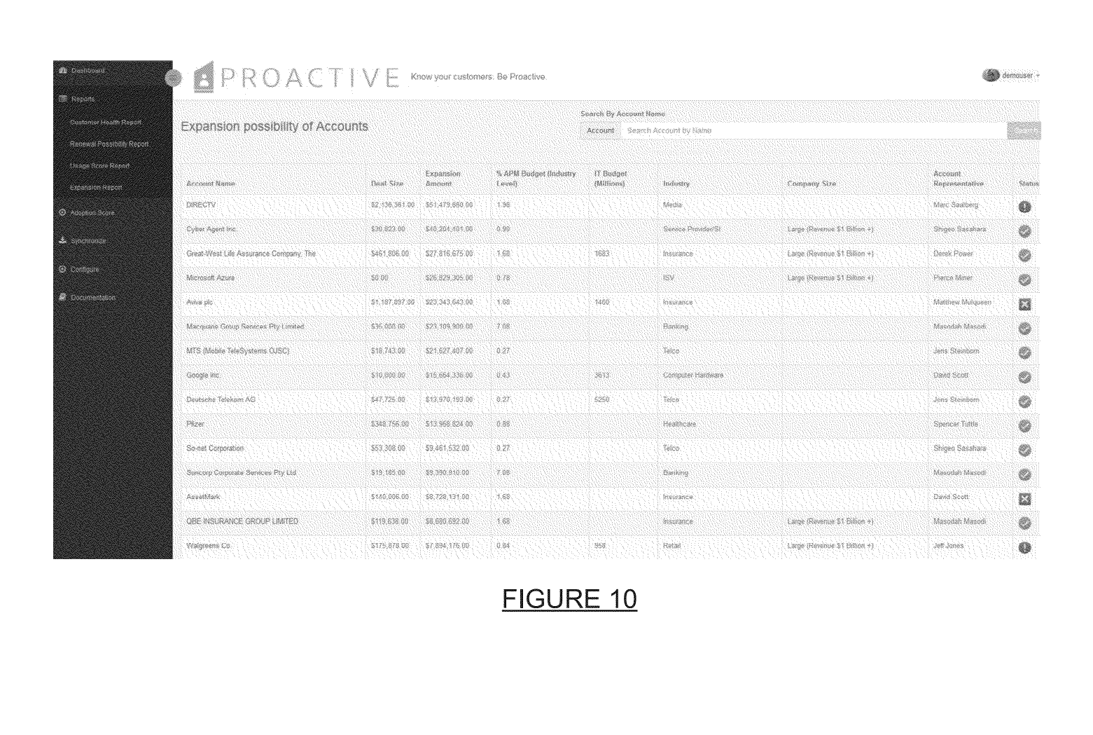

FIG. 10 is an exemplary interface providing an expansion possibility report. Interface of FIG. 10 provides data such as account name, deal size, expansion amount, percent of application program monitoring budget, IT budget, the industry, company size, account representative in this status of the account

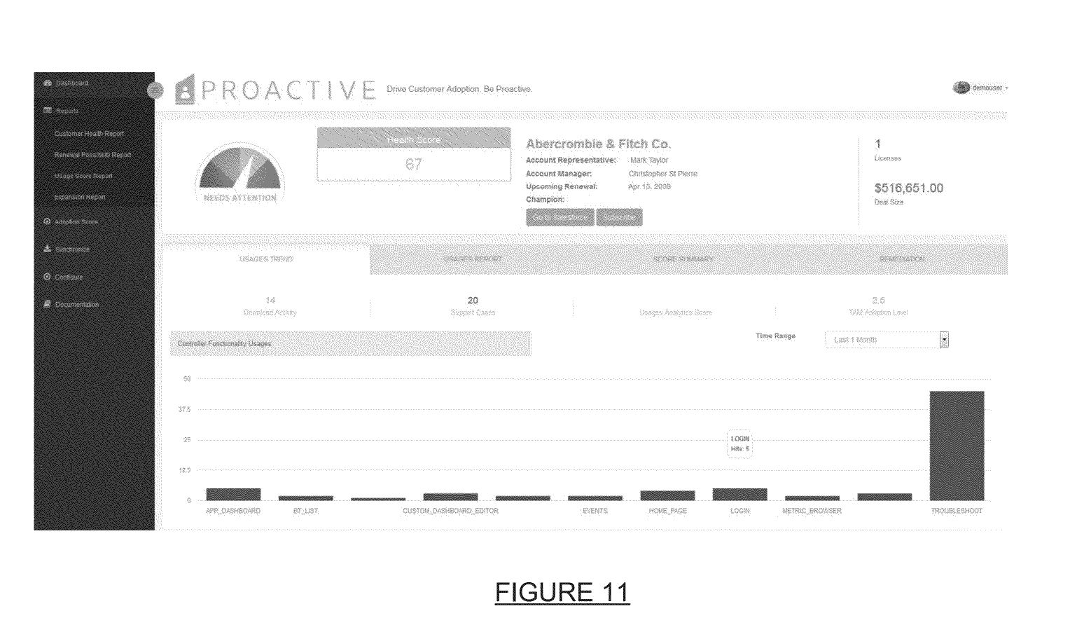

Other usage data may include usage trends as shown in FIG. 11. Usage trends may include download activity, number of support cases, the usages analytic store, and a Tam adoption additionally, controller functionality usages may be shown for each of several applications. A renewal score may be calculated based on an adaption level, customer service tickets, download activities, and other data. Based on the renewal score, we meet remediation activities may be recommended such as reaching out to the account, providing an alert to other members of a team for the account, and other data and messages.

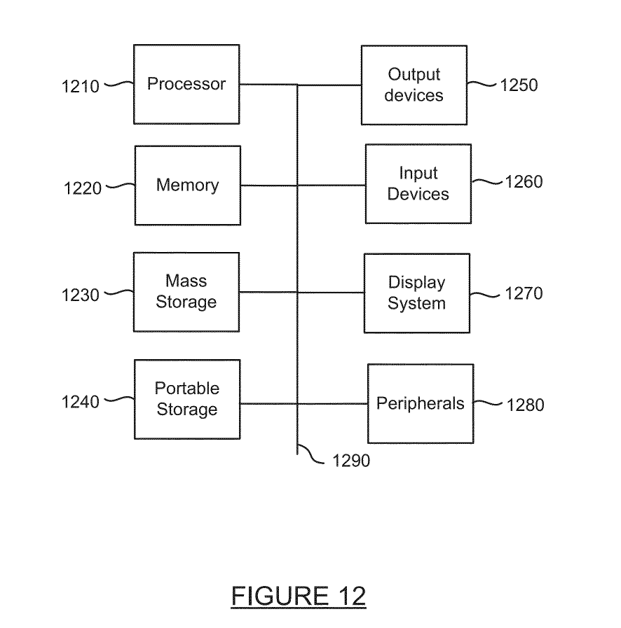

FIG. 12 is a block diagram of a computer system for implementing the present technology. System 500 of FIG. 5 may be implemented in the contexts of the likes of clients 105 and 192, network server 125, application servers 130-160, asynchronous server 170, and data stores 190-185. A system similar to that in FIG. 5 may be used to implement mobile device 115, but may include additional components such as an antenna, additional microphones, and other components typically found in mobile devices such as a smart phone or tablet computer.

The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive or an optical disk drive, is a non-volatile storage device for storing data and instructions for use by processor unit 1210. Mass storage device 1230 can store the system software for implementing embodiments of the present invention for purposes of loading that software into main memory 1210.

Portable storage device 1240 operates in conjunction with a portable non-volatile storage medium, such as a floppy disk, compact disk or Digital video disc, to input and output data and code to and from the computer system 1200 of FIG. 12. The system software for implementing embodiments of the present invention may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, or a pointing device, such as a mouse, a trackball, stylus, or cursor direction keys. Additionally, the system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information, and processes the information for output to the display device.

Peripherals 1280 may include any type of computer support device to add additional functionality to the computer system. For example, peripheral device(s) 1280 may include a modem or a router.

The components contained in the computer system 1200 of FIG. 12 are those typically found in computer systems that may be suitable for use with embodiments of the present invention and are intended to represent a broad category of such computer components that are well known in the art. Thus, the computer system 1200 of FIG. 12 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

When implementing a mobile device such as smart phone or tablet computer, the computer system 1200 of FIG. 12 may include one or more antennas, radios, and other circuitry for communicating over wireless signals, such as for example communication using Wi-Fi, cellular, or other wireless signals.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for determining the health of a network application customer, comprising:
monitoring by one or more agents a usage of an application management system, the one or more agents executing on one or more servers that implement the application management system;
automatically collecting usage data by a controller for the application management system from the one or more agents;
receiving by the controller a human generated score associated with the entity using the application management system;
generating by the controller a health score for the entity based on the automatically collected data and the human generated score; and
reporting the health score to the entity.

2. The method of claim 1, wherein the automatically collected data includes the number of agents logged into a second controller.

3. The method of claim 1, wherein the automatically collected data includes a number of times a dashboard associated with the application management system is accessed.

4. The method of claim 1, wherein generating by the controller the health score includes:
determining a number of points to apply towards the health score based on the usage data.

5. The method of claim 1, further comprising determining a health level based on the health score and health level ranges associated with the entity industry and company size.

6. The method of claim 1, wherein the human generated score represents a technical success of the application management system.

7. The method of claim 1, further comprising generating a renewal possibility report.

8. The method of claim 1, further comprising generating an expansion report.

9. A non-transitory computer readable storage medium having embodied thereon a program, the program being executable by a processor to perform a method for determining the health of a network application customer, the method comprising:
automatically collecting usage data by a controller for an application management system from one or more agents, the one or more agents monitoring a usage of the application management system, the one or more agents executing on one or more servers that implement the application management system;
receiving by the controller a human generated score associated with the entity using the application management system;
generating by the controller a health score for the entity based on the automatically collected data and the human generated score; and
reporting the health score to the entity.

10. The non-transitory computer readable storage medium of claim 9, wherein the automatically collected data includes the number of agents logged into a second controller.

11. The non-transitory computer readable storage medium of claim 9, wherein the automatically collected data includes a number of times a dashboard associated with the application management system is accessed.

12. The non-transitory computer readable storage medium of claim 9, wherein generating by the controller the health score includes:
determining a number of points to apply towards the health score based on the usage data.

13. The non-transitory computer readable storage medium of claim 9, further comprising determining a health level based on the health score and health level ranges associated with the entity industry and company size.

14. The non-transitory computer readable storage medium of claim 9, wherein the human generated score represents a technical success of the application management system.

15. The non-transitory computer readable storage medium of claim 9, further comprising generating a renewal possibility report.

16. The non-transitory computer readable storage medium of claim 9, further comprising generating an expansion report.

17. A server for determining the health of a network application customer, comprising:
a processor;
a memory; and
one or more modules stored in memory and executable by a processor to monitor by one or more agents a usage of an application management system, the one or more agents executing on one or more servers that implement the application management system, automatically collect usage data for the application management system from the one or more agents, receive a human generated score associated with the entity using the application management system, generate a health score for the entity based on the automatically collected data and the human generated score, and report the health score to the entity.

18. The system of claim 17, wherein the automatically collected data includes the number of agents logged into a controller.

19. The system of claim 17, wherein the automatically collected data includes a number of times a dashboard associated with the application management system is accessed.

20. The system of claim 17, wherein controller determines a number of points to apply towards the health score based on the usage data.

21. The system of claim 17, the one or more modules further executable to determine a health level based on the health score and health level ranges associated with the entity industry and company size.

22. The system of claim 17, wherein the human generated score represents a technical success of the application management system.

23. The system of claim 17, the one or more modules further executable to generate a renewal possibility report.

24. The system of claim 17, the one or more modules further executable to generate an expansion report.
